(19) United States
(12) Patent Application Publication
(10) Pub. No.: US 2013/0169993 A1
(43) Pub. Date: Jul. 4, 2013

(54) Automated Production of Printed Products From Online Content

(71) Applicants: Joshua Stein, New Haven, CT (US); David Goldenberg, San Francisco, CA (US)

(72) Inventors: Joshua Stein, New Haven, CT (US); David Goldenberg, San Francisco, CA (US)

(73) Assignee: PigSpigot, Brooklyn, NY (US)

(21) Appl. No.: 13/342,309

(22) Filed: Jan. 3, 2012

(51) Int. Cl. G06K 15/02

(52) U.S. Cl. 358/1.15

(57) ABSTRACT

A system and method for automated production of tangible printed products using content derived from an online source is presented. In some instances the content is identified by a client and is automatically printed to an object followed by delivery of the object to a desired recipient. A URL identifying the desired content is prepared by a Web server and provided to an application server, which URL identifies graphical and other content for printing and which URL can cause billing of the operator of the Web server for the printed product making services.

### TECHNICAL FIELD

The present disclosure relates to systems and methods for producing products containing printed features derived from online graphical and other content.

### BACKGROUND

It is useful to print images and other information onto various media. For example, conventional printers can receive signals representing a digital image or textual file and process the received signals to produce tangible printed products on sheets of paper or other printing media. Images have been printed onto other useful and entertaining objects such as books, calendars, T-shirts, coffee mugs, key chains, and so on. This process involves providing an image to be printed from a computer (e.g., a digital image file which may be of a JPG, TIFF, PNG, BMP or other format) to a printing machine (e.g., a laser printer, dot matrix printer, dye sublimation printer, lithography apparatus, or other printer) that can make visible printed copies of the image onto the printing medium or object of choice.

Source imagery and files can be obtained for printing from a variety of locations. In some cases, the images or files are located in storage on a computer storage medium such as a hard drive or removable memory device of a computer. In other cases the source file containing an image to be printed may be received from a friend by electronic mail. In yet other instances one can download an image from a network such as the Internet prior to printing it. In each of these examples the image is transferred from an original location to a local storage location on a computer connected to both the source and to a printer.

FIG. 1 illustrates the general operation of prior systems 10 that have enabled combining graphical (e.g., image) data 110 with text data 120 to form a printed output such as a custom greeting card 100 to be ordered or sent by a sender 12. The greeting card may then be delivered by ordinary or electronic mail to a recipient 14. These systems lack an optimum integration capability and are usually limited in their technical and user experience capabilities. For example, a limiting set of images 110 may be available to the sender 12 making a card 100. As will be seen below, the prior systems 10 are not well suited for online commercial transactions and are cumbersome from a programming and administration perspective.

### SUMMARY

The present invention relates to automated generation of printed objects such as greeting cards from content available on a network. Once a user selects the graphical and other message content the user can activate an interactive element such as a script-generated button provided in a browser for the user. A uniform resource locator (URL) includes information about image locations and other information as selected by the sending user. The URL is prepared by the front-end web server and delivered to an application server using a POST method or other method once a user activates a corresponding link or button on the browser page. The application server then retrieves the indicated content from the indicated locations and prepares a printer ready file suitable for sending to a print server or a printer. Once the greeting card is printed, the address of the desired recipient is used to process the card for mailing to the recipient. Billing is facilitated by exchange of customer identification information or keys indicating which entity is making a request for the card to be printed.

### BRIEF DESCRIPTION OF THE DRAWINGS

A preferred embodiment of the invention will now be described by way of specific example with reference to the accompanying drawings, in which:

FIG. 1 illustrates a way in which content and images were combined into a custom greeting card according to the prior art.

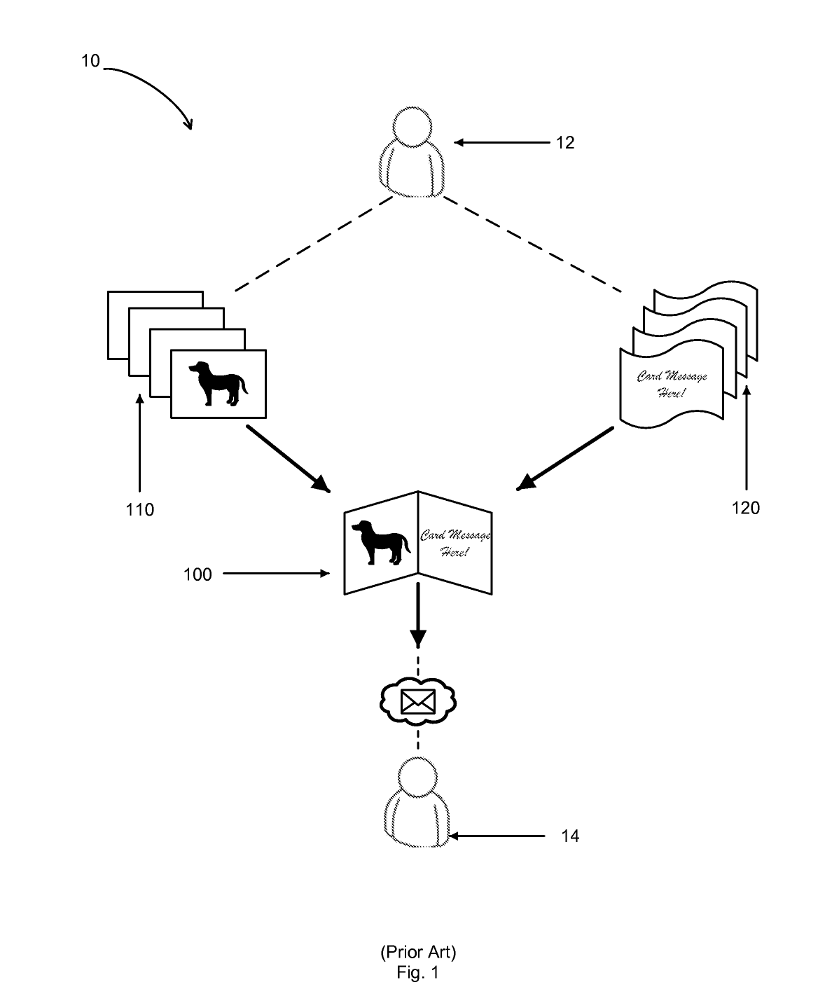

FIG. 2 illustrates an aspect of integration of script into a HTML page according to the present disclosure;

FIG. 3 illustrates an exemplary architecture for a system for delivering printed content according to the present disclosure; and

FIG. 4 illustrates an exemplary method for providing printed content according to the present disclosure.

### DETAILED DESCRIPTION

As discussed briefly above, users like to make and send greeting cards and other printed and customized materials to recipients such as friends and loved ones or business associates, customers, etc. Existing systems, mentioned earlier, are lacking in both their technical design and architecture as well as in their ability to satisfy modern business needs in this space from a provider and from a customer's point of view.

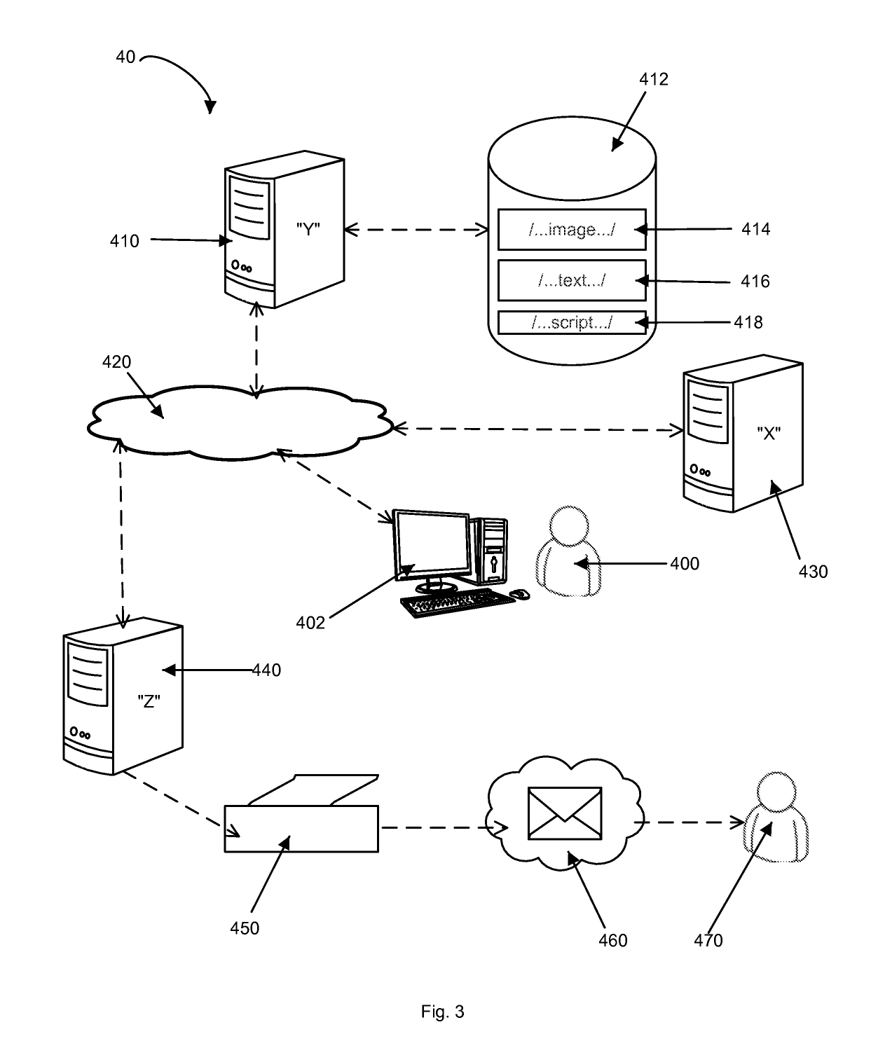

FIG. 3 illustrates an exemplary embodiment of a system 40 for generating and providing custom printed content. The various remote parts of the system are coupled by a network 420, which may include the Internet or portions connecting people and machines over a wired or wireless communication channel.

A user 400 interacts with the system 40 by way of a client machine 402 such as a personal computer. The client machine may be a thin client and may be a personal portable device such as a laptop computer, notepad, touch pad, gaming device, home entertainment system, personal digital assistant (PDA), smart phone, and so on. The client machine 402 includes hardware and can execute machine-readable instructions, which may be stored in a memory storage device in client machine 402. Some of the capabilities of the client machine 402 include the ability to take input and provide output (I/O) to interact with and be responsive to user 400 who in this instance desires to send a printed product to a recipient 470. Some of the capabilities of the client machine 402 include the ability to exchange data with other machines over network 420. Therefore, in one embodiment, client machine 402 includes a network card or similar communication hardware and software to send and receive data. Any appropriate communication protocol may be employed by client machine 402 in interacting with the network 420 or other components coupled to network 420.

Client machine 402 may also include hardware and software for accessing the Internet or the World Wide Web (Web). The software installed and running on the client 402 to achieve this is sometimes referred to as a Web browser or simply a browser. This allows the user 400 through client machine 402 to browse the content of the Web, including graphical and textual content of pages available on the Web for public or private viewing. The content available for browsing may include hypertext markup language (HTML) or extended markup language (XML) or other types of pages optimized for viewing by browsers on client machines.

A Web server or simply a server 410 is used to generate and provide the above browsable content to clients. Server 410 is programmed to receive requests for specific pages of content according to a protocol. The server 410 will fetch required information from a database 412 coupled to server 410. The database 412 may be collocated with server 410 or may be remote from server 410 and coupled to it by a network connection. Content that may be placed into a page for serving to a client includes images 414, text 416 and script 418. The formatting and syntax of the content for placement into browsable pages is understood by those skilled in the art. Typically, server 410 will fetch some content responsive to a request made by clients, incorporate the content into a page conforming to a protocol, and serve the resulting page and content back to the requesting client. The electronic addresses of the server 410, client 402 and possibly the content are all determined according to an addressing scheme. For example, components may interact and exchange information over the Internet according to the TCP/IP communication protocol. The information is moved from one location to the other over the network 420 in packets complying with such standards and protocols as needed.

Now turning to the generation of printed objects from online electronic content we examine an illustrative process that takes place concomitant with the above process for viewing online information. Once user 400 has browsed online content with his or her client machine 402, the user 400 may wish to send a greeting card 460 or other printed object to a recipient 470. The user 400 is therefore a sender in this example. The greeting card medium is an example that can be extended to other media such as T-shirts, drinking cups, key chains, novelties, decals or printable objects of an essentially arbitrary nature. Here the greeting card 460 that sender 400 wishes to send to recipient 470 is to include text, images or other content printed on the greeting card. The content can be owned by the user 400 (who can upload words and pictures for example) or the content may be owned by a server 410 or provider who operates server 410, which can be stored in database 412.

As mentioned earlier, server 410 is adapted to serve browsable formatted pages over the network 420 to client machine 402 for the benefit of sender 400. The server 410 may be specifically adapted and programmed to provide pages carrying viewable information and interactive elements allowing sender user 400 to select and organize or design a greeting card or other printable media product. User 400 can therefore select from viewable graphical information what graphical content his or her greeting card 460 will be provided with. In addition, user 400 may select pre-existing text to include in the card 460 or may type custom text messages to be printed on the card 460.

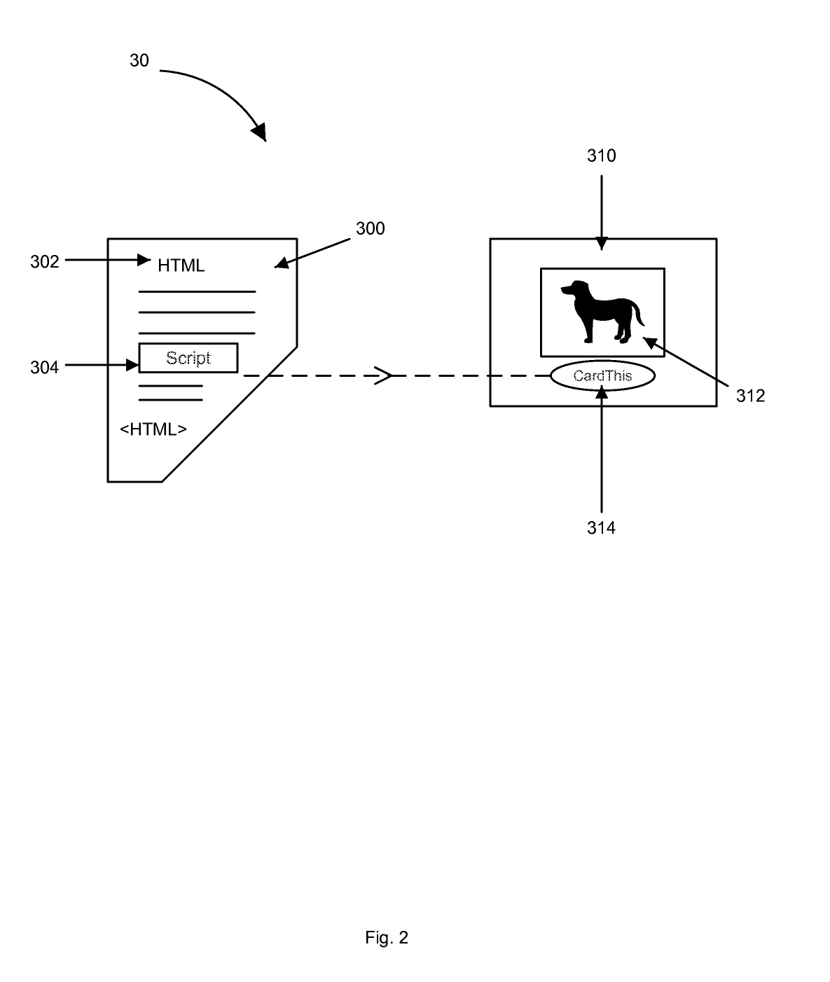

FIG. 2 illustrates a simple example of a HTML page 300 served by browser 410 to client machine 402. The page includes a number of HTML compliant syntax lines 302. The page includes links to other pages, links to graphical files, etc. as is understood by those skilled in Web programming and online content design. In addition, page 300 includes a simple script 304 that is delivered for execution when the HTML content of page 300 is processed by the client machine 402. The script 304 causes the browser display 310 of client machine 402 to display a button 314 or other selectable user interface element indicating that clicking the button 314 or selecting the user interface element will cause a greeting card to be generated. For example, the words “Click to Create Card” or “CardThis®” or other such phrase may be used on or in conjunction with presenting button 314 to its user.

The present example, which is not meant as limiting but rather by way of illustration of the present embodiment, allows user 400 to select one of a plurality of available images to include in the greeting card, as well as a written message (or greeting) to be printed in the card. The user 400 can select the image (or images) to be included in the card by clicking on a “clickable” button shown on a page the user is browsing. The button is represented by a graphical and familiar user interface element such as a round, oval, or rectangular graphical object displayed in the browser screen of client machine 402. The button may include suggestive text to encourage the user 400 to click it, or text explaining what the purpose of the button is. Once clicked or selected, the action of clicking or selecting the button 314 will trigger further actions and take the user 400 to a page to further achieve generation of the printed greeting card object.

In one embodiment, card 460 is to include a traditional single fold rectangular paper stock. The card will therefore be a rectangle, folded along a central line thereof, and forming two outside surfaces or pages (the card's front and the card's back pages) as well as two interior surfaces or pages (the inside left and inside right pages). Content may be placed as desired onto any of the foregoing four surfaces or pages of the card. Typically, greeting cards have an image adorning their front outside cover, sometimes with a brief portion of text, as well as some written message, sometimes with a graphic, on the inside pages thereof. The back exterior page of a greeting card is usually left blank, or may include a simple small graphic or name and logo of the maker of the greeting card.

In one embodiment, graphical content on the Internet which is available for placement into greeting cards or other printable media is indicated by its proximity or other relationship to a button as described above. For example, a picture available for placement in a greeting card might have the button 314 located below such an image in the browser display.

According to an embodiment, a server 410 receives requests (e.g., by a URL, POST or other method) from a client for content to be placed into a printed product. Server 410 combines the desired data into electronic files that are stored in a database 412 accessible to computers having the proper access keys and codes and addresses to access the stored data files. Therefore, an application server 430 can be directed to retrieve the stored data files and information responsive to a user's request as prepared by server 410. The application server 430 can follow a given link and use a suitable application program interface (API) to interact with web server 410 to obtain graphical and other data for placement onto the desired printed media or object (e.g., greeting card).

Once application server 430 has obtained the necessary graphical files and other information, it formats the graphical and other information into a printer-ready format or file (e.g., a portable document format PDF file). The printer-ready formatted file can then be passed on to a printer 450 for printing the content on the medium of choice (e.g., greeting card stock). Alternatively, the printer-ready file can be passed over network 420 to a print server 440, which is in turn coupled to printer 450 and prints the object (e.g., greeting card 460) for delivery to recipient 470.

We now turn to a preferred but exemplary method for exchange of data to enable the above process in the context of making and delivering a greeting card from sender 400 to recipient 470.

User 400 accesses the Internet (or other network) 420 using a client computer 402 running a browser or similar program for displaying content to user 400. User 400 uploads his or her own imagery for placement on a greeting card, or browses available images and content provided by web server 410. Web server 410 may deliver to client 402 pictures of people, things, or other graphical content, as well as text and other interactive features the user 400 can choose to include in his or her greeting card. The web server 410 may access a storage device or database 412 that holds the electronic content.

Sender user 400 makes a selection of one or more graphical images for placing on the front cover of the greeting card and/or the inside and/or other portion of the card 460. Sender user 400 also types into a text entry box some customized greeting message, or chooses a pre-composed message using a user interface on client machine 402 as provided by a browser having scripted interactive programmed content.

The exchanges between server 410 and client 402 are made by way of HTTP requests and responses. Once the graphical and other content is decided upon, a simulated image of the final greeting card's appearance may be provided to the user 400 for confirmation. Additionally, user 400 provides “TO” and “FROM” data indicative of who the card is to be delivered and indicative of who the card is from, respectively. This information includes a mailing address of the recipient 470. The sending user 400 may also enter his or her billing information (e.g., credit card data) so that the operator of the card making service can charge the appropriate party for the cost associated with making and delivering the card. Next, a user interface element (e.g. a HTML generated element) such as a button or link is provided to user 400 who clicks on the user interface element or selects it to finalize the transaction.

Once the card elements and content have been finalized, the server 410 prepares a URL that is delivered, e.g., using a POST method, to an application server 430. The application server may be operated by a different organization or entity than that operating web server 410. The application server is thus provided with a URL containing various pieces of information: some information identifies the location where the one or more graphical files are stored that are to be placed on the front and/or inside pages of the greeting card; some information in the URL identifies the TO and the FROM addresses of sender 400 and recipient 470; other information in the URL identifies the organization or entity that is making the request for the card (e.g., a commercial partner or retailer); yet other information in the URL may contain formatting instructions, data indicating the desired font size, color, card stock background imagery, and other information. The application server 430 acts responsive to the URL received to fetch the necessary content (e.g., images) from the indicated storage locations given in the URL.

Once the application server 430 has fetched and sorted out all of the information provided to it in the URL composed by web server 410, the application server 430 proceeds to generate a unitary print-ready file, such as a PDF file including all of the desired graphical and other information that will appear in the card 460. The application server will therefore compose, for example, one or more PDF files that printer 450 or print server 440 can use in printing card 460. A single PDF file may be used, or two PDF files corresponding to the outside sheets and the inside sheets respectively, or four PDF files may be used corresponding to each face of the four pages of a conventional folded greeting card. In sum, these print-ready files are delivered to the printing facility or part of system 40 for generation of the card and the mailing label or envelope that is ready to receive postage for mailing to the recipient 470's address.

In some embodiments, billing information and account information is also included in the content that is securely exchanged between components of system 40. For example, in one instance, application server 430 may be operated by a company “X” and another partner or customer company “Y” operates web server 410 and is signed up with “X” to use the card making facilities of “X” described above. In this scenario, “Y” provides its billing information (e.g., banking information, credit card information, etc.) to “X” and in return “Y” receives a customer key or code or ID from “X.” The customer key is used to identify card making requests each time “Y” composes a card making request URL for “X.” The card making request URL will include the customer key, which will cause “X” to bill “Y” to its given credit or banking account as agreed. In this way, “Y” may operate a front-end customer-facing web site that offers images and other content for users (400) to pick from to make their cards. Then “Y” merely packages the customer 400 requests and mailing information and gives this information to “X” who goes forward with making the card files and causing the card to be printed and mailed to recipient 470. “X” and others do not need to receive the credit card information of sending user 400. Sending user 400's credit card or billing information is processed by front-end entity “Y”. Back-end or application server 430 operator “X” only needs the identification information of its partner “Y” to bill “Y” for the services rendered by “X.” Similarly, if the printing itself is accomplished by yet another party “Z”, “Z” does not need the billing information of customer 400 or of front-end server 410 operator “Y”. “Z” will receive identifying information from “X” and bill “X” according to the agreements between “Z” and “X.”

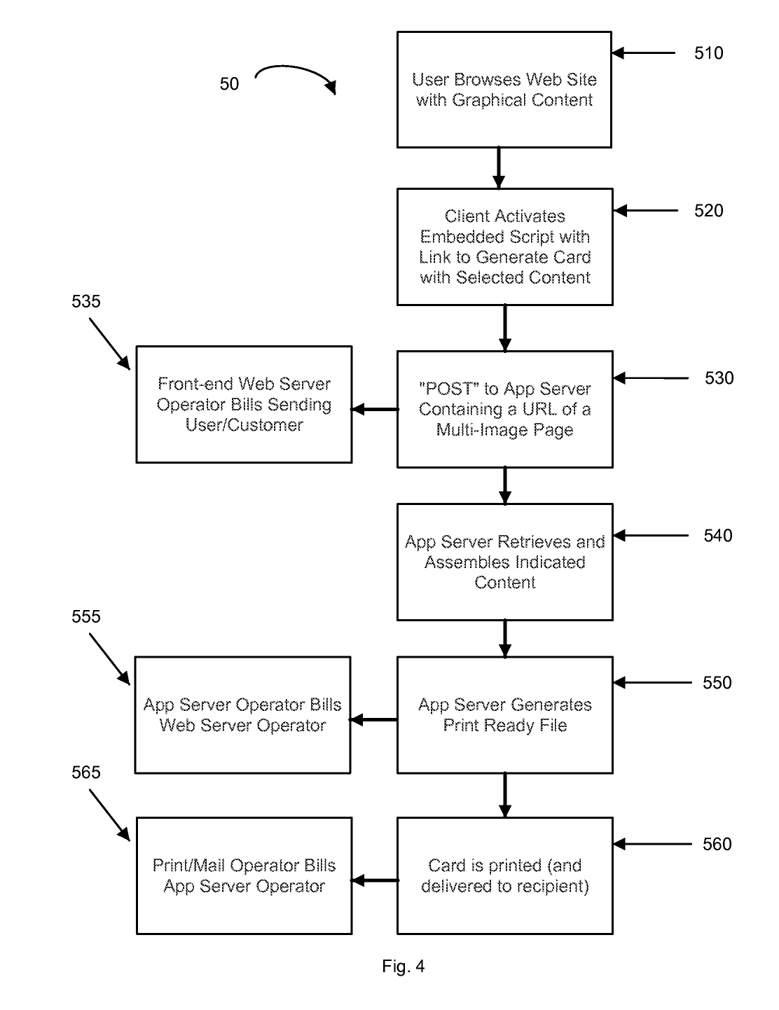

FIG. 4 illustrates an exemplary method 50 for generating and delivering a printed product, e.g., a greeting card, using the previously described system and concepts.

At step 510 the sending user browses a Web site containing graphical content or accepting user graphical content for placement into or onto the printed object, e.g., the greeting card. The user selects image(s) that he or she desires to be included in the greeting card.

At step 520 the client activates an embedded HTML script with a link to generate a greeting card having the selected content.

A URL is generated by a web server that includes all address information and image location to assemble a final card from. The URL is “POST”ed at step 530 to an application (App) server, including multi-image page content location accessible to the application server.

At step 540 the application server retrieves and assembles the indicated graphical and other information and creates a print ready file (e.g., a PDF) for printing or sending to a print server. Once the card and mailing label or envelope are printed at step 560 they are processed for mailing to the intended recipient.

There is a business advantage in operating the system according to the above method. The front-end of the operation can be handled by a web server that comprises an image server offering a plurality of images to users to select from. The front-end server 410 can be operated as discussed above by a web server operator who charges the sending customer for the cards ordered at step 535.

The application server can be operated by a second operator so that the second operator of the application server operator bills the front end server operator at step 555.

At step 565 a print server operator (if involved) can bill the application server operator for the cost of printing and mailing the greeting card.

The embodiments and description and drawings provided herein are illustrative and allow those skilled in the art to understand the inventions and to incorporate the inventions into systems and methods comprehended by the present disclosure and claims. The present embodiments should therefore not be considered exhaustive or limiting, but other derivative and similar techniques and devices relating hereto should be considered covered by the present scope of invention as well.

What is claimed is:

1. A method for automated preparation of a printed product, comprising:
presenting a user with a plurality of content options for inclusion in a printed product;
accepting the user's selections as to content from said content options;
providing an element in a page which the user can activate by selection of said element in said page;
providing a URL including information indicative of said user's selections and other information to print on the printed product;
generating a print ready file from information and content derived from and as indicated by said URL; and
printing said printed product using said print ready file.

2. The method of claim 1 further comprising accepting an address of a recipient to which the printed product is to be delivered.

3. The method of claim 2, further comprising processing said printed product for shipping to said recipient at said address.

4. The method of claim 1, said step of providing the URL comprising POSTing said URL to an application server capable of generating said print ready file.

5. The method of claim 4, further comprising providing billing information from a Web server to said application server, said billing information identifying an account of an operator of said Web server.

6. The method of claim 1, generating said print ready file comprising generating a PDF file suitable for printing onto said printed product.

7. The method of claim 1, generating said print ready file further comprising determining a layout for said selected content onto pages of a greeting card.

8. The method of claim 1, further comprising accepting custom greeting messages from a user for inclusion on the printed product.
